(19) United States
(12) Patent Application Publication
(10) Pub. No.: US 2019/0094615 A1
(43) Pub. Date: Mar. 28, 2019

(54) BACKLIGHT PANEL FOR PROVIDING AREA BACKLIGHTING OF A PANEL DISPLAY DEVICE

(71) Applicant: Visteon Global Technologies, Inc., Van Buren Township, MI (US)

(72) Inventors: Daniel J. Gullick, Chelmsford (GB); Pawel Murzyn, Chelmsford (GB)

(73) Assignee: Visteon Global Technologies, Inc., Van Buren Township, MI (US)

(21) Appl. No.: 16/139,886

(22) Filed: Sep. 24, 2018

(30) Foreign Application Priority Data
Sep. 22, 2017 (GB) 1715361.0

(51) Int. Cl. G02F 1/1335; F21V 8/00

(52) U.S. Cl. CPC G02F 1/133603; G02B 6/0051; G02B 6/0055

(57) ABSTRACT

This invention relates to a backlight panel for a panel display device, comprising a light pipe, at least one source of illumination and a diffuse reflector. The light pipe has a first boundary surface comprising a first substantially planar surface interrupted by a first pattern of discrete surface relief features for extracting light from the light pipe and for directing said extracted light at the diffuse reflector, and a second boundary surface comprising a second substantially planar surface interrupted by a second pattern of laterally elongate surface relief features, each comprising an inclined surface angled towards the light source for directing light internally reflected from the second boundary surface towards the first boundary surface at a correspondingly lower angle of incidence. The areal density of the first pattern varies across the first side and generally increases along the transmission direction.

### BACKGROUND

### Field of the Invention

This invention relates to a backlight panel for providing area backlighting of a panel display device for displaying one or more backlit graphic information features, and also to a panel display device comprising such a backlight panel.

### Related Art

A common type of backlight panel for providing area backlighting of a panel display device, for example an automotive gauge in a vehicle dashboard, uses a light pipe having a generally planar form. The light sources are typically white or coloured light emitting diodes (LEDs). Light is injected into one or more edges of the light pipe, which then has light extraction features, for example frosting or surface relief features on one side, for scattering light out of the light pipe and in the backlight illumination direction. Usually, a significant proportion of light is lost at the end of the light pipe, and even if scattered or reflected by light extraction features may not be sent in the right direction to contribute to the backlighting. The result of wasted light is increased electric power consumption and/or reduced backlight intensity.

There is often a trade-off between the complexity of the illumination arrangement and the achievable evenness of illumination. For example, it is known that providing light sources on two opposite edges, so that light propagates within the planar light pipe in two opposing directions, can provide a higher degree of uniformity of backlight illumination. Space must be provided for such additional light sources, usually to one or more sides of the backlight panel. It is also necessary to accommodate associated drive electronics.

It would be desirable to improve the efficiency of such backlight panels, for example, to increase display brightness, or allow a corresponding reduction in power consumption, and preferably without increasing the size of the backlight panel. Use of fewer LEDs is, in general, also desirable as this can permit a reduction in display unit cost. Such cost concerns are particularly important in automotive applications.

It is an object of the present invention to provide a backlight panel for providing area backlighting of a panel display device which address at least some of these issues.

### SUMMARY OF THE INVENTION

According to a first aspect of the present invention, there is provided a backlight panel for providing area backlighting of a panel display device for displaying one or more backlit graphic information features, wherein the backlight panel comprises a light pipe, at least one source of illumination and a diffuse reflector; the light pipe comprises a substantially plate-like body of an optically transmissive material, said body comprising opposite first and second sides providing, respectively, opposite first and second boundary surfaces of the light pipe for guiding light along the light pipe by means of internal reflections off said boundary surfaces, said sides being bounded by a peripheral edge of said body; the peripheral edge comprises an input edge portion at which said source of illumination is provided to inject light into the light pipe for transmission by internal reflections off said boundary surfaces along a transmission direction within the light pipe, the transmission direction defining a lateral direction extending transversely to the transmission direction; the diffuse reflector is positioned opposite the first side so that light escaping the light pipe through the first boundary surface is diffusely reflected by the diffuse reflector back into the light pipe and generally towards the second side, said area backlighting being provided by light escaping from the light pipe through the second boundary surface; the first boundary surface of the light pipe comprises a first substantially planar surface interrupted by a first pattern of surface relief features, said surface relief features being discrete and the discrete surface relief features being spaced apart across the first side both in the transmission direction and in the lateral direction to form said first pattern for extracting light from the light pipe and for directing said extracted light at the diffuse reflector, the proportion of the first boundary surface covered by the discrete surface relief features as compared with said first planar surface defines an areal density of said first pattern, and the areal density of said first pattern varies across the first side and generally increases along the transmission direction; and the second boundary surface comprises a second substantially planar surface interrupted by a second pattern of surface relief features, each of said surface relief features being elongate in the lateral direction and said longate surface relief features being spaced apart from one another across the second side in the transmission direction to form said second pattern, each elongate surface relief feature comprising an inclined surface, each of said inclined surfaces being angled towards said light source relative to said second planar surface of the second boundary surface for directing light internally reflected from the second boundary surface towards the first boundary surface at a correspondingly lower angle of incidence.

As is conventional, angles of incidence are measured with respect to a perpendicular, or “normal”, to a surface on which a light ray is incident. A perpendicular ray has an angle of incidence of 0° and parallel ray has an angle of incidence of 90°.

To facilitate the total internal reflection and partial reflection necessary for the light pipe to convey light, the first and second boundary surface may be bounded by a substance having a different, and preferably lower, index of refraction than the light transmissive material. Most conveniently, this substance is air. The diffuse reflector may therefore be separated from the first boundary surface by a gap. The gap is preferably a gap of a transparent substance having an index of refraction lower than that of the transmissive material of the light pipe, for example air.

The first and second substantially planar surfaces are most preferably optically smooth, to facilitate internal reflections within the light pipe. There is therefore no need to apply any reflective coating on the first and second boundary surfaces.

In a preferred embodiment of the invention, the plate-like body has a substantially rectangular outline, and either the long axis or the short axis of the rectangle is substantially parallel with the transmission direction of the injected light. In a preferred embodiment of the invention, the plate-like body has an input edge portion that is cylindrically curved by 90° so that light is injected by one of more light sources into the light pipe at right angles to the first and second planar surfaces, which begin after the cylindrically curved portion of the plate-like body. The radius of curvature may be between about 5 mm and about 10 mm. If a more compact arrangement is needed, then alternatively the 90° bend can be achieved by a reflecting surface on the second side of the light pipe angle at 45° to both the planar surfaces and the terminal edge portion. The advantage of these arrangements is that the light sources, for example light emitting diodes (LEDs), and associated circuit board and driver electronics, and be mounted on a plane beneath the level of the first and second planar surfaces.

In a preferred embodiment of the invention, the diffuse reflector is a sheet of opaque, white material, for example a filled or foamed plastics material. The diffuse reflector is preferably a Lambertian reflector.

The boundary surfaces need not be exactly planar and may, for example, be gently curved with respect to the extent of the light pipe, without substantially affecting the ability of injected light to traverse the light pipe by multiple internal reflections of the first and second boundary surfaces, or without departing from the principles of the invention. In the context of the present invention, a curved surface subtending an angle of ±5° across its full extent, may be considered to be substantially planar.

The invention addresses the issue of the total amount of transmitted light in the light pipe becoming depleted, as light escapes from the second side for backlighting, moving along the transmission direction. In order to provide even backlighting, it is necessary for an ever higher proportion of light to be extracted along the length of the transmission direction.

Backlighting may be provided, in part, by light rays that are transmitted through the second boundary surface towards the display device without having first interacted with the diffuse reflector. Such rays will tend to be angled non-uniformly, for example preferentially in a direction parallel with the transmission direction. To provide more even back lighting, it is therefore advantageous to ensure that as much of the backlight as possible originates from light reflectively scattered by the diffuse reflector.

The invention addresses this issue in two interlinked ways. First, the areal density of the first pattern generally increases with distance from said source of illumination so that, in use, an increasing proportion of the transmitted light remaining in the light pipe is extracted, as the total amount of transmitted light in the light pipe decreases moving away from the illumination source. This helps to maintain the intensity of illumination striking the diffuse reflector, even as the total amount of light remaining in the light pipe diminishes. Second, due to the presence of the second pattern, an increased proportion of light internally reflected from the second boundary surface is directed towards the first boundary surface at a correspondingly lower angle of incidence (i.e. closer to a right angle). This happens because light reflecting off the laterally elongate inclined surfaces will be directed towards the first boundary surface with a proportionate decrease in angle of incidence in order to increase the proportion of light escaping from the first side of the light pipe towards the diffuse reflector.

This makes it more likely a ray of light will either be transmitted through the planar portion of the first boundary surface (instead of being internally reflected again), or that the ray of light will be deflected out of the light pipe towards the diffuse reflector by the first surface relief pattern (also, instead of being internally reflected again). The net effect therefore, is that as the total amount of transmitted light in the light pipe decreases moving away from the illumination source, light is extracted towards the diffuse reflector more efficiently.

Therefore, even when light is injected into only one of the side edges, the input edge portion, good intensity and evenness of backlight intensity is achievable across the extent of the second boundary surface, even proximate the periphery of the light pipe where light intensity within the light pipe from one or more light sources tends to drop off.

The peripheral edge may comprise a pair of opposite lateral edge portions. The elongate surface relief features may extend between the lateral edge portions. Thus the second pattern may extend between said lateral edge portions.

The peripheral edge may comprise a terminal edge portion towards which the injected light is generally transmitted. The lateral edge portions, when present, may each extend between the input edge portion and the terminal edge portion.

The areal density of the first pattern may vary in the lateral direction and may generally increase towards the lateral edge portions, to further enhance the uniformity of the light output.

Preferably, each of the laterally elongate surface relief features extends continuously across the second pattern. The second pattern may be a striped pattern.

The proportion of the second boundary surface covered by the elongate surface relief features as compared with said second planar surface defines an areal density of the second pattern. The areal density of the second pattern may vary across the second side and may generally increase along the transmission direction. In this case, the areal density of the second pattern generally increases with distance from the source of illumination. The effect of the increased density of the second pattern magnifies the effect of increased density of the first pattern in the transmission direction.

The elongate surface relief features may comprise grooves in the second planar surface, each groove having one side wall which provides the inclined surface.

Each groove may be V-shaped in cross-section, with a first side of the V-shape (the one closest to the, or each, light source), providing the inclined surface.

A second side of the V-shape groove (the one farthest from the, or each, light source), may be inclined with respect to the second planar surface at an opposite angle to that of the first side of the V-shape groove.

The elongate surface relief features may comprise ridges in the second planar surface, each ridge having one side wall which provides said inclined surface.

The elongate surface relief features may comprise a mixture of ridges and grooves, for example an alternating series.

In the case of ridges, each ridge may have an inverted V-shape, i.e. having opposite ramp sides, a first side of the ramp sides (the one furthest from the or each light source) providing the inclined surface.

A second ramp side of each ridge (the one closest to the, or each light source) may be inclined with respect to the second planar surface at an opposite angle to that of the first ramp side of the corresponding ridge.

The angle of the inclined surfaces may generally increase, relative to the second planar surface, along the transmission direction, so that the angle of incidence of transmitted light within the light pipe is correspondingly reduced.

The, or each, source of illumination may inject light into the light pipe along substantially the entire input edge portion. In this case, it is advantageous if the second pattern is a pattern of substantially straight elongate surface relief features.

Alternatively, the or each, source of illumination may inject light into the light pipe at a central part of the input edge portion, in which case it is advantageous if the second pattern is a pattern of substantially concentric arcs centered generally on this central part of the input edge portion.

In this way, the orientation of the inclined surfaces of the surface relief features of the second pattern is kept as close as possible to perpendicular to the transmission direction, at all points along the lateral extent of the second pattern.

To compensate for variations in light output close to the input edge portion, the first pattern may include a region of increased areal density adjacent or proximate the input edge portion.

The discrete surface relief features of the first pattern may be arranged in a reticulated pattern. The discrete surface relief features may comprise pits in the first planar surface. The discrete surface relief features may comprise bumps on the first planar surface. The discrete surface relief features may comprise a mixture of pits and bumps.

The pits or bumps may be any convenient shape, for example forming three sides of a tetrahedron, or forming four sides including the apex of a square pyramid. In preferred embodiments of the invention, the pits or bumps are substantially hemispherical.

Also according to the invention, there is provided a graphic display device for displaying one or more graphic information features to a user and a backlight panel for providing area backlighting of a panel display device, the graphic display device having a front face and a rear face, the front face being oriented to present said graphic information features to a user of the panel display, and the rear face being configured to receive said backlight illumination from the first side of the backlight panel, wherein the backlight panel is according to the first aspect of the invention.

The backlit graphic information features may, of course, be any type of symbol, image or text.

### BRIEF DESCRIPTION OF THE DRAWINGS

The invention will now be further described by way of example only, and with reference to the accompanying drawings, in which like reference numerals are used for like features, and in which:

FIG. 1 is a cross-sectional view of a panel display device having a backlight panel;

FIGS. 2a to 2c are perspective, top and bottom views respectively of a light pipe for use in the backlight panel of FIG. 1, illustrating a pattern of surface relief features on top and bottom surfaces of the light pipe;

FIGS. 3a and 3b are top and cross-sectional views of a variant of the light pipe, illustrating a pattern of surface relief features on the top surface of the light pipe;

FIG. 4 is a cross-sectional view of another variant of the light pipe, illustrating a pattern of surface relief features on the top surface of the light pipe;

FIG. 5 is a bottom view of a further variant of the light pipe, illustrating a pattern of surface relief features on the bottom surface of the light pipe;

FIG. 6 is a top view of a second light pipe for use in the backlight panel of FIG. 1, illustrating a pattern of surface relief features on the top surface of the light pipe;

FIG. 7 is a top view of a variant of the second light pipe, illustrating a pattern of surface relief features on the top surface of the light pipe;

FIG. 8 is a top view of a third light pipe for use in the backlight panel of FIG. 1, illustrating a pattern of surface relief features on the bottom surface of the light pipe;

FIG. 9 is a top view of a fourth light pipe for use in the backlight panel of FIG. 1, illustrating a pattern of surface relief features on the bottom surface of the light pipe;

FIGS. 10a and 10b show the light output from a light pipe having a pattern of surface relief features only on its bottom surface in accordance with the prior art; and

FIGS. 11a to 11c show the light output from a light pipe according to the present invention having patterns of surface relief features on its bottom and top surfaces.

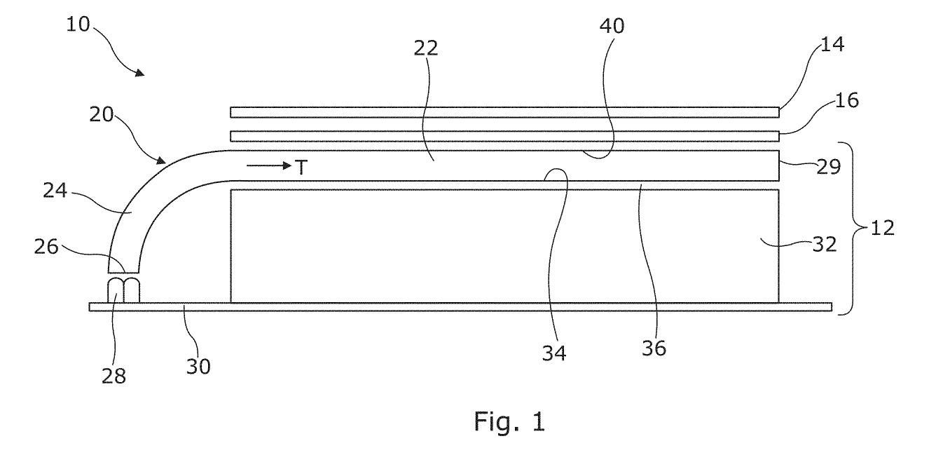

Throughout this specification, the terms top, bottom, upper, lower and equivalent and related terms will be used with reference to the orientation of the device as shown in FIG. 1. It will be understood, however, that the device could be used in any orientation.

### DETAILED DESCRIPTION

FIG. 1 shows a panel display device 10 having a backlight panel, indicated generally at 12, and a graphic display device 14 in the form of a liquid crystal display panel. A plate-like diffuser 16 is disposed between the display panel 14 and the backlight panel 12.

The backlight panel 12 comprises a light pipe 20 having a generally plate-like main body 22 with a curved end part 24 that provides an input edge portion of the light pipe 20. An illumination source 28, comprising a bank of light emitting diodes (LEDs) in this example, is disposed adjacent to an end surface 26 of the input edge portion 24. The input edge portion 24 of the light pipe 20 is of part-cylindrical form so that light injected from the illumination source 28 into the input edge portion 24 is guided through a 90-degree bend to enter the plate-like main body 22 of the light pipe 20. The light is directed by the light pipe 20 generally along a transmission direction T towards a terminal edge 29 of the main body 22, opposite the input edge portion 24. The LEDs and associated drive electronics (not shown) are mounted on a circuit board 30 that extends parallel to the light pipe 12.

A diffuse reflector 32 is disposed adjacent to the main body 22 of the light pipe 20, between a first planar surface 34 of the light pipe 20 and the circuit board 30. In this example, the reflector 32 is formed from a sheet of a suitable opaque, white material, such as a filled plastics material. The reflector 32 is spaced from the first planar surface 34 by a gap 36. In this example, the gap 36 is an air gap, but the gap 36 may instead be filled with a material having an index of refraction that differs from the index of refraction of the material of the light pipe 20, or the gap 36 may be omitted so that the reflector 32 is in contact with the first planar surface 34 of the light pipe 20.

The diffuser 16 is disposed adjacent to a second planar surface 40 of the light pipe 20 (i.e. above the top surface 40 of the main body 22 of the light pipe 20, in the orientation shown in FIG. 1). The diffuser 16 is preferably a Lambertian diffuser.

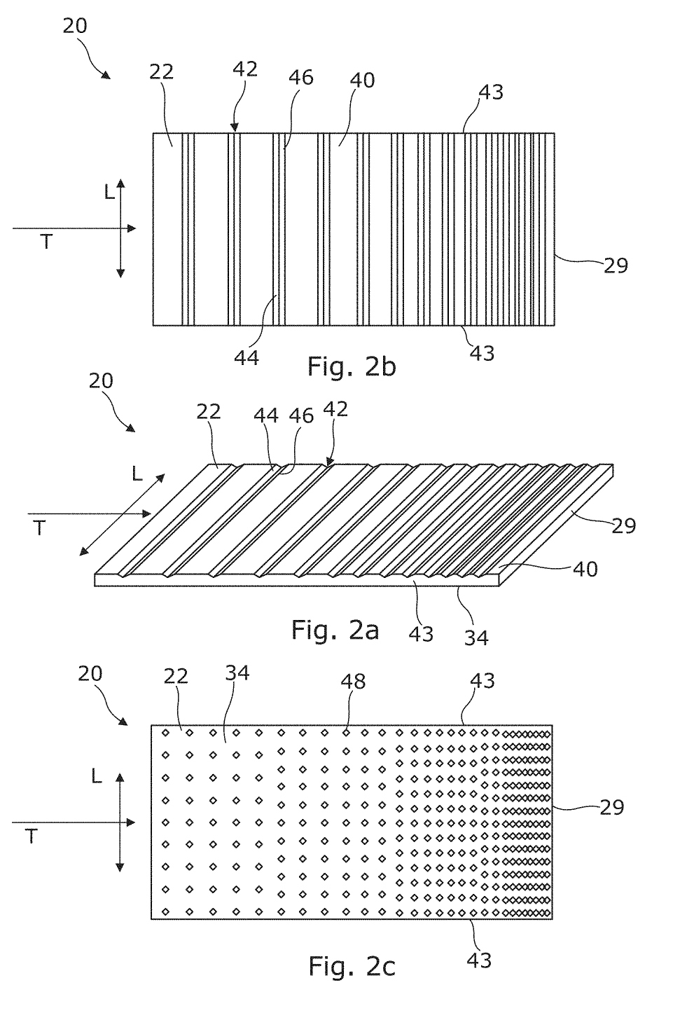

FIGS. 2a, 2b and 2c show the main body 22 of the light pipe 20 in perspective, top and bottom views. The first (bottom) planar surface 34 and the second (top) planar surface 40 provide respective first and second boundary surfaces of the light pipe 20. Both the first and second planar surfaces 34, 40 are provided with a plurality of surface relief features, as will now be described.

Referring first to FIGS. 2a and 2b, the second (top) planar surface 40 is interrupted by a plurality of surface relief features comprising grooves 42 arranged in a striped pattern across the body 22. The grooves 42 are spaced apart from one another in the transmission direction T, and each groove 42 is elongate in a lateral direction that extends transversely to the transmission direction T to first and second lateral edges 43 of the body 22.

Each groove 42 is generally V-shaped in cross section. A first side 44 of the V-shape groove 42, closest to the input edge portion 24 (not shown in FIGS. 2a to 2c), provides an inclined surface that is angled towards the input edge portion 24 relative to the plane of the second planar surface 40. Said another way, the first side 44 of the V-shape groove 42 is inclined towards the transmission direction T. A second side 46 of the V-shape, furthest from the input edge portion 24, is inclined relative to the plane of the second planar surface 40 at the opposite angle, away from the transmission direction T.

In this example, each of the grooves 42 has the same dimensions. However, the spacing of the grooves 42 decreases moving in the transmission direction T towards the terminal edge 29. Thus the separation between adjacent grooves 42 in a region of the second planar surface 40 closest to the input edge portion 24 is larger than the separation between adjacent grooves 42 in a region of the second planar surface 40 further from the input edge portion 24. The area of the second planar surface 40 that is covered or occupied by the grooves 42, compared with the total area of the second planar surface 40, defines an areal density of the surface relief features on the second planar surface 40. As a result of the decreasing separation between the grooves 42, this areal density increases along the transmission direction T.

As shown in FIG. 2c, the surface relief features 48 on the first (bottom) planar 30 surface 34 are discrete, meaning that each surface relief feature 48 is spaced apart from all of its neighbours. Accordingly, the surface relief features 48 on the first planar surface 34 are spaced apart from one another both in the transmission direction T and the lateral direction L. In this example, the surface relief features 48 on the first planar surface 34 comprise pits or indents having a generally pyramidal shape.

In this example, all of the pits 48 have the same dimensions. However, the areal density of the pits (i.e. the area of the first planar surface 34 that is covered or occupied by the pits 48, compared with the total area of the first planar surface 34) increases along both the transmission direction T, moving towards the terminal edge 29, and along the lateral direction L, moving from a centre line of the main body 22 towards the lateral edges 43.

In use, light propagates from the illumination source 28, through the input edge portion 24 and into the main body 22 of the light pipe 20. As is known in the art, a substantial fraction of the light incident on the first and second boundary surfaces, formed respectively by the first and second planar surfaces 34, 40, is internally reflected within the light pipe 30.

The pits 48 on the first planar surface 34 act as light extraction features that preferentially direct light incident on the pits 48 out of the light pipe 20 and towards the reflector 32. Light escaping from the first planar surface 34 is reflected by the reflector 32 back into the light pipe 20 and generally towards the second planar surface 40. Light escaping from the second planar surface 40 is diffused by the diffuser 16 to provide diffuse area backlighting for the LCD display 14.

The total amount of transmitted light remaining in the light pipe 20 decreases with distance from the illumination source 28. However, the proportion of the remaining light extracted from the light pipe 20 through the first planar surface 34 increases with the areal density of the pits 48. Therefore, the increasing areal density of the pits 34 on the first planar surface 34 helps to compensate for the fall-off of light and to maintain the intensity of illumination striking the reflector 32.

The grooves 42 on the second planar surface 40 serve to increase the overall light output from the light pipe 20, and also help to compensate for the fall-off of remaining light within the light pipe 20. Light striking the inclined surfaces formed by the first sides 44 of the grooves 42 is internally reflected towards the first planar surface 34 at a generally lower angle of incidence (i.e. closer to a right angle), compared to light that strikes the second planar surface 40 away from the grooves 42. This increases the likelihood of the light leaving the light pipe 20 from the second planar surface 40. The increasing areal density of the grooves 42 with distance from the illumination source 28 therefore also helps to increase the proportion of remaining light that is extracted from the light pipe 20 for reflection by the reflector 32.

The surface relief features 42, 48 on the first and second planar surfaces 34, 40 therefore act in combination to extract light from the light pipe 20 in a way that produces relatively uniform area backlighting for the display 14 over the whole of the required area, even though the light pipe 20 is illuminated from only one side.

The patterns of surface relief features on the first and second surfaces may differ from those illustrated in FIGS. 2a to 2c.

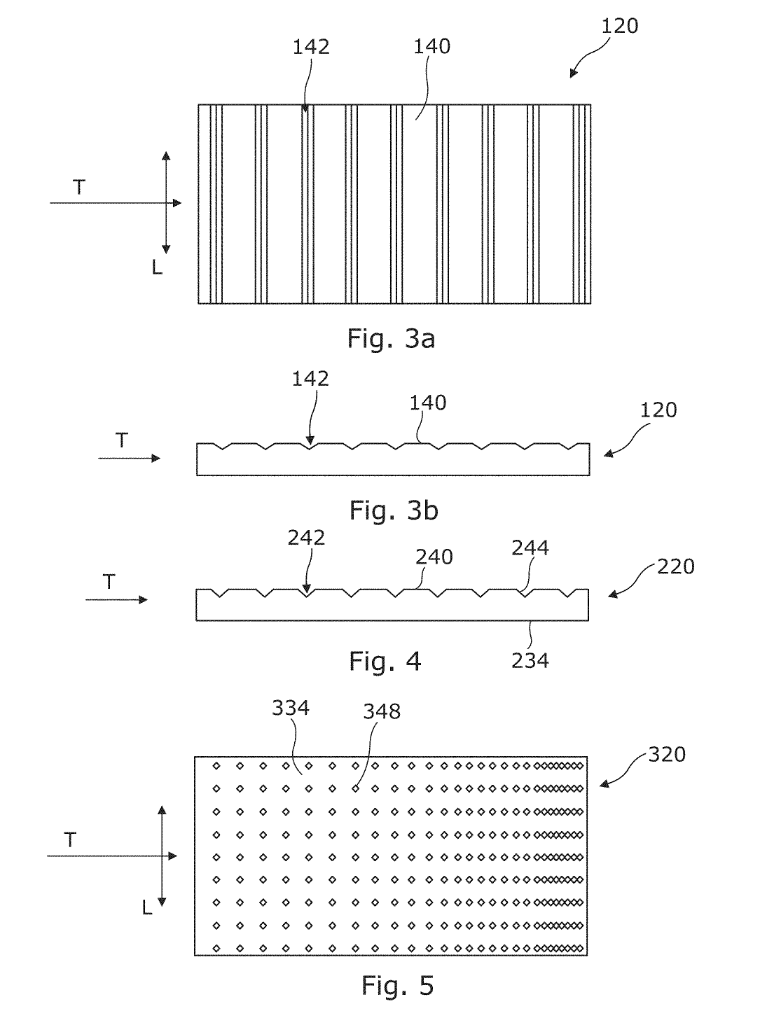

For example, FIGS. 3a and 3b are top and cross-sectional views of another light pipe 120 having an alternative pattern of surface relief features on the second (top) planar surface 140. The surface relief features comprise grooves 142 that are similar to the grooves 42 described above with reference to FIGS. 2a to 2c. However, in this alternative example, the grooves 142 are regularly spaced in the transmission direction T. In this example, an improvement in the uniformity of the area backlighting can be achieved primarily by the varying areal density of the surface features provided on the first (bottom) planar surface 134, which are not visible in FIGS. 3a and 3b. The surface relief features 142 on the second planar surface 140 primarily act to increase the overall level of light extraction from the light pipe 120.

FIG. 4 is a cross-sectional view of another light pipe 220 with a further alternative pattern of surface relief features on the second (top) planar surface 240. Again, the surface relief features comprise elongate grooves 242 that extend across the second planar surface 240 in the lateral direction. The grooves 242 are regularly spaced in the transmission direction T, but the depth of each groove 242 increases with distance along the transmission direction T, moving away from the illumination source. In this way, the angle of inclination of the inclined surface formed by the first side 244 of each of the grooves 242 increases with distance along the transmission direction T.

As a result, light striking the inclined surfaces formed by the first sides 244 of the 10 grooves 242 is internally reflected towards the first planar surface 234 at a generally decreasing angle of incidence moving away from the illumination source, helping to increase the proportion of remaining light that is extracted from the light pipe 220 through the first planar surface 234 as a function of distance along the transmission direction T.

FIG. 5 shows the bottom side of a further light pipe 320 with an alternative pattern of surface relief features on the first planar surface 334. As in the example of FIGS. 2a to 2c, the surface relief features comprise discrete pits 348 having a generally pyramidal shape. However, the areal density of the pits 348 increases only in the transmission direction T and is constant across the lateral direction L.

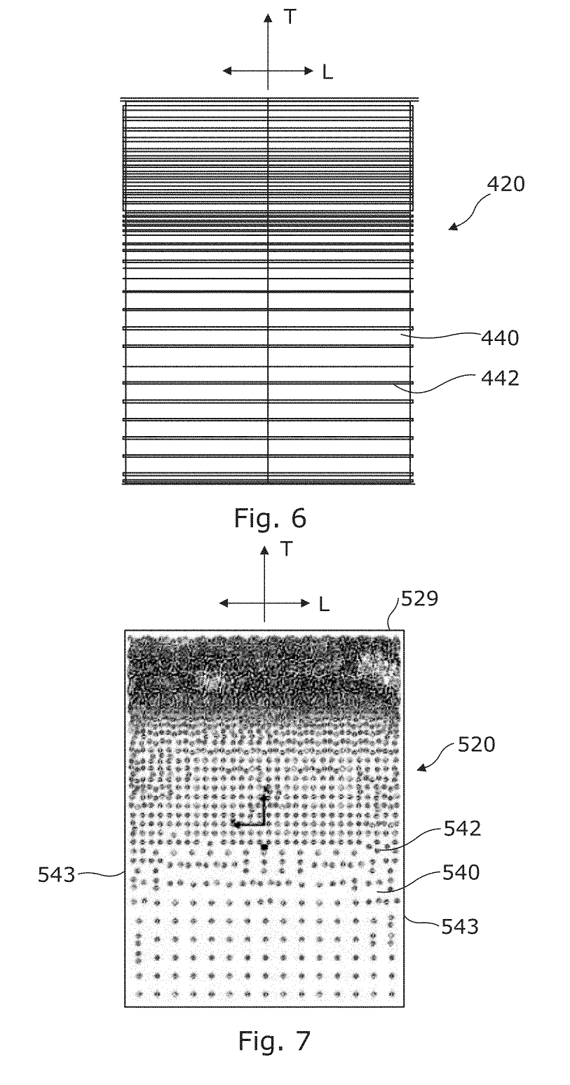

FIG. 6 is a top view of a still further light pipe 420, showing another alternative surface relief pattern on the second planar surface 440. In this example, the surface relief features again comprise lines or grooves 442 that are elongate in the lateral direction L, with the areal density of the pattern increasing with distance along the transmission direction T.

FIG. 7 is a top view of yet another light pipe 520, showing a further alternative surface relief pattern on the second planar surface 540. In this case, the surface 30 relief features are discrete and comprise indents or pits 542, rather than elongate grooves. The pits 542 are spaced apart from one another in the transmission direction T and in the lateral direction L. The areal density of the pits 542 increases in both the transmission direction T and in the lateral direction L. In this way, the pits 542 on the second planar surface 540 are arranged in a similar way to the pits 48 on the first planar surface 34 of the light pipe 20 described above with reference to FIGS. 2a to 2c.

The pits 542 on the second planar surface 540 act in a similar way to the grooves 42, 142, 242, 442 described above, in that light incident on the pits 542 on the second planar surface 540 tends to be internally reflected towards the first planar surface (not shown in FIG. 7) at a generally lower angle of incidence to enhance light extraction from the first planar surface. In this example, the density of pits 542 increases towards the lateral edges 543 and the terminal edge 529 to counteract further the drop-off in light intensity in these areas of the light pipe 520.

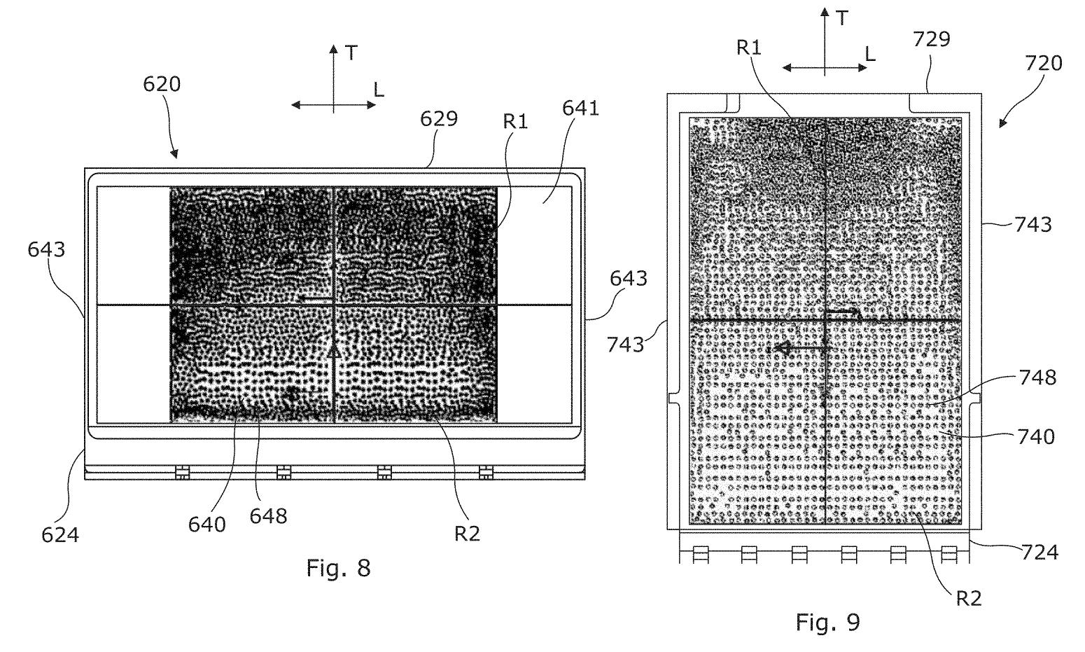

FIG. 8 shows the first (bottom) planar surface 640 of another light pipe 620. In this case, the light pipe 620 has an aspect ratio in which the width of the light pipe 620 between the lateral edges 643 is larger than the length of the light pipe 620 between the input edge portion 624 and the terminal edge 629. As in previous examples, the surface relief features comprise pits 648. The areal density of the pits 648 generally increases with distance along the transmission direction T and in the lateral direction 20 L. However, the distribution of the pits 648 is such that the regions with the highest areal density (marked R1 in FIG. 8) lie away from the centre line of the light pipe and are instead closest to the lateral edges 643.

A further region R2 in which the pits 648 have relatively high areal density is 25 disposed adjacent to the input edge portion 624 of the light pipe 620. The increased areal density in this region R2 compensates for a reduction in light output close to the transition between the curved end part and the planar main body of the light pipe 620 due to the geometry of the curved end part.

It will also be noted that, in the example of FIG. 8, the surface relief pattern is provided over a smaller area than the total planar extent of the light pipe 620. In this case, therefore, the light pipe 620 includes margins 641 in which no surface relief features are present.

FIG. 9 shows the first (bottom) planar surface 740 of a further light pipe 720 having an aspect ratio in which the width of the light pipe 720 between the lateral edges 743 is less than the length of the light pipe 720 between the input edge portion 724 and the terminal edge 729. The surface relief features again comprise pits 748. The areal density of the pits 748 generally increases with distance along the transmission direction T and in the lateral direction L. In this case, the region R1 with the highest areal density of pits 748 lies on the centre line of the light pipe 720, adjacent to the terminal edge 729.

In the FIG. 9 example, a smaller increase in areal density of the pits is provided in the region R2 adjacent to the input edge portion 724, compared with the equivalent region R2 in the FIG. 8 example. This is because, in the FIG. 9 example, the curved part of the input edge portion 724 has a smaller radius of curvature than in the FIG. 8 example. More generally, the areal density of surface relief features required in the region R2 adjacent to the input edge portion increases with the efficiency of light transmission through the curved end part and into the main body, and therefore depends on the geometry of the light pipe. For example, in a light pipe with a curved end part having a relatively small radius of curvature, light leakage from the light pipe in the region R2 adjacent to the input edge portion may be sufficient so that no increase in areal density is required in this region.

For both the first and second planar surfaces of the light pipe, the patterns of surface relief features can be optimised to achieve uniform illumination across the backlit area and to achieve a relatively high overall light output. The optimum patterns for a particular case will depend on, for example, the shape and size of the light pipe, the nature and intensity of the illumination source, the size of any margins, and so on.

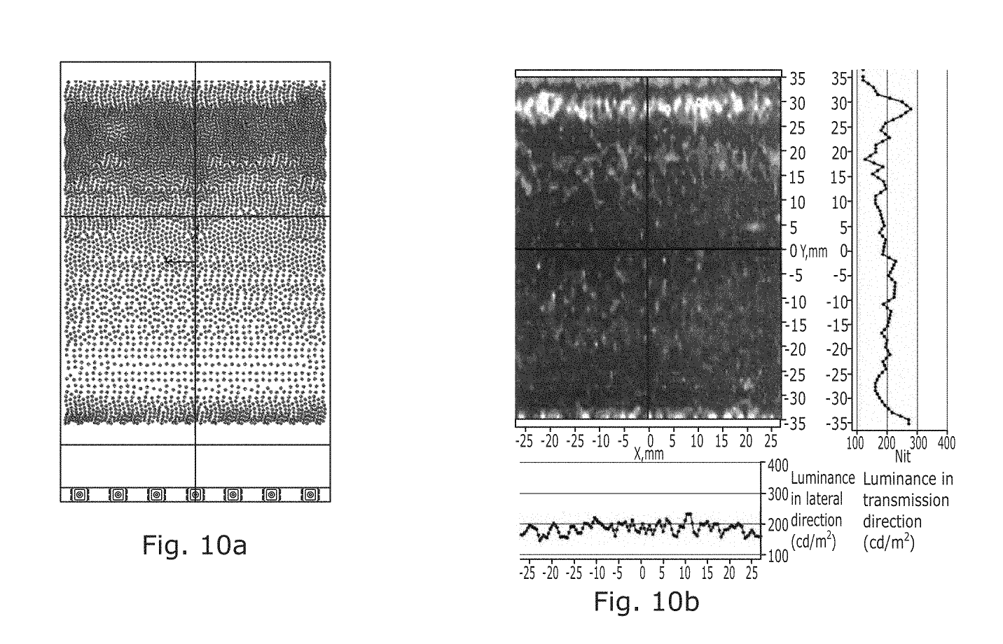

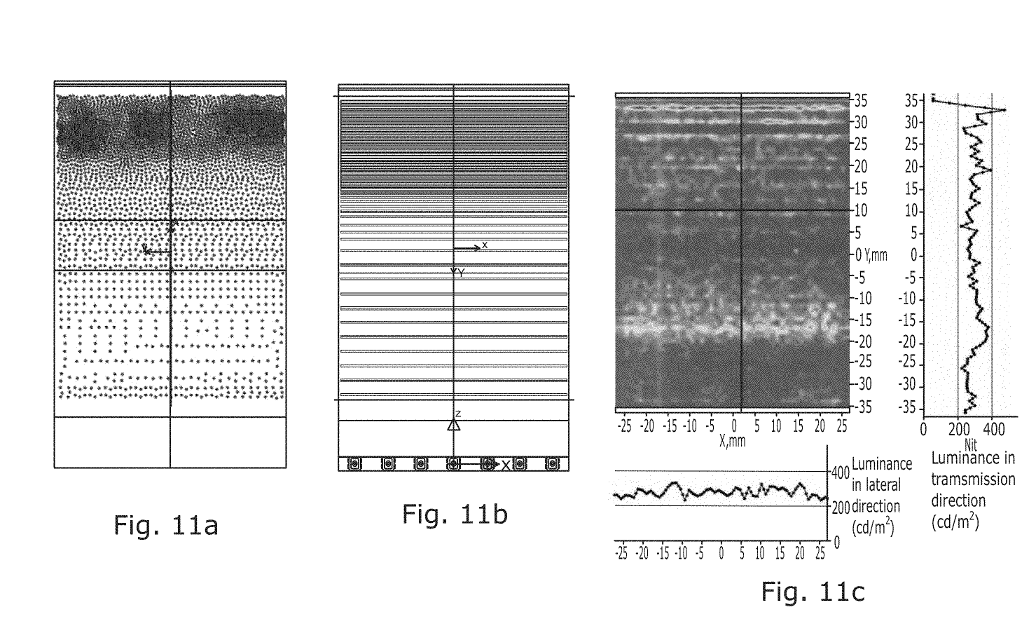

Simulated values of luminance from two backlight panels of the type described with reference to FIG. 1 are shown in FIGS. 10 and 11. In both cases, the illumination source comprises seven LEDs, each having a light output of 4.3 lumens (Im) and equally spaced across the width of the input edge portion. The light pipe is of a poly(methyl methacrylate) (PMMA) material. The first and second planar surfaces of each light pipe have a length of 73 mm and a width 54 mm. A Lambertian diffuser is provided, and the reflector is of a white reflective material.

FIGS. 10a and 10b relate to a light pipe with a pattern of discrete surface relief features on the first (bottom) surface as shown in FIG. 10a and with no surface relief features on the second (top) surface. Each of the surface relief features comprises a hemispherical pit with a radius of 0.3 mm. FIG. 10b shows the simulated light output from this light pipe. The achieved light intensity has an average value of 187 cd/m² and the light output is substantially non-uniform across the illuminated area.

FIGS. 11a to 11c relate to a light pipe according to the present invention, having a pattern of discrete surface relief features comprising hemispherical-shaped pits on the first (bottom) surface as shown in FIG. 11a, in which the areal density of the pits generally increases in the transmission direction T and the lateral directions L. Each pit again has a radius of 0.3 mm. The second (top) surface has a pattern of elongate surface relief features comprising V-shaped grooves as shown in FIG. 11b. Each groove has a width (in the plane of the second surface) of 0.5 mm and a depth (perpendicular to the second surface) of 0.25 mm, and the areal density of the grooves increases in the transmission direction. FIG. 11c shows the simulated light output from this light pipe. In this case, the achieved light intensity has an average value of 307 cd/m² and the uniformity of light output across the illuminated area is substantially improved.

Further modifications and variations of the backlight panel and particularly the light pipe can also be contemplated.

The input edge portion of the light pipe may have a different shape to the part-cylindrical shape described above. For example, the input edge portion may be coplanar with the main body or may comprise a peripheral edge of the main body, so that the whole light pipe is slab- or plate-shaped. In these cases, one or more reflective surfaces may be positioned adjacent to the input edge portion to direct light from the illumination source into the input edge portion. Alternatively, the illumination source may be disposed in the plane of the main body of the light pipe and arranged to inject light directly along the transmission direction.

It is conceivable that the light pipe could be illuminated from two or more sides by a corresponding plurality of illumination sources, so as to illuminate a plurality of areas 10 of the light guide. In such cases, the light injected from each illumination source defines a respective transmission direction within the light guide, and the above-described patterns of surface relief features on each of the faces of the light guide may be duplicated to provide enhanced light extraction and to compensate for the light drop-off in each of the illuminated areas of the light guide.

The surface relief features may differ from those described above. Whilst in the illustrated examples, the surface relief features are in the form of depressions or indentations in the respective planar surfaces, the surface relief features could instead be raised from the planar surfaces, or include both raised and indented parts. Discrete surface relief features could be conical, frustoconical, part-spherical, part-cylindrical, pyramidal, trapezoidal, or any other suitable shape. Elongate or linear surface relief features could be U-shaped grooves or ridges, part-cylindrical grooves or ridges, V-shaped grooves or ridges, or any other suitable shape.

The elongate surface relief features on the second surface may be parallel to one another, as in the illustrated examples. Alternatively, the elongate surface relief features could be curved or arc-shaped. For example, in arrangements in which the illumination source injects light into the light pipe at a central part of the input edge portion, the elongate surface relief features may form a pattern of substantially concentric arcs centred generally on said central part.

The shape of the light pipe can be adapted as appropriate for a particular application. For example, the light pipe could be rectangular, as illustrated, to illuminate a rectangular-shaped area of a graphic display device, or could be arc-shaped or part-circular, to illuminate a correspondingly-shaped area of a gauge-type display.

The invention provides a light pipe for illumination applications (e.g. display or gauge illumination) which combines light extraction patterns on two opposing surfaces of the light pipe. This allows for a greater portion of the light entering the light pipe to be put to useful service (i.e. contributing to overall luminance) compared to prior art light pipe designs which include extraction patterns on only one surface.

Further modifications and variations not explicitly described above may also be made without departing from the scope of the invention as defined in the appended claims.

1. A backlight panel for providing area backlighting of a panel display device for displaying one or more backlit graphic information features, wherein the backlight panel comprises a light pipe, at least one source of illumination and a diffuse reflector;
the light pipe comprises a substantially plate-like body of an optically transmissive material, said body comprising opposite first and second sides providing, respectively, opposite first and second boundary surfaces of the light pipe for guiding light along the light pipe by means of internal reflections off said boundary surfaces, said sides being bounded by a peripheral edge of said body;
the peripheral edge comprises an input edge portion at which said source of illumination is provided to inject light into the light pipe for transmission by internal reflections off said boundary surfaces along a transmission direction within the light pipe, the transmission direction defining a lateral direction extending transversely to the transmission direction;
the diffuse reflector is positioned opposite the first side so that light escaping the light pipe through the first boundary surface is diffusely reflected by the diffuse reflector back into the light pipe and generally towards the second side, said area backlighting being provided by light escaping from the light pipe through the second boundary surface;
the first boundary surface of the light pipe comprises a first substantially planar surface interrupted by a first pattern of surface relief features, said surface relief features being discrete and the discrete surface relief features being spaced apart across the first side both in the transmission direction and in the lateral direction to form said first pattern for extracting light from the light pipe and for directing said extracted light at the diffuse reflector, the proportion of the first boundary surface covered by the discrete surface relief features as compared with said first planar surface defines an areal density of said first pattern, and the areal density of said first pattern varies across the first side and generally increases along the transmission direction; and the second boundary surface comprises a second substantially planar surface interrupted by a second pattern of surface relief features, each of said surface relief features being elongate in the lateral direction and said elongate surface relief features being spaced apart from one another across the second side in the transmission direction to form said second pattern, each elongate surface 5 relief feature comprising an inclined surface, each of said inclined surfaces being angled towards said light source relative to said second planar surface of the second boundary surface for directing light internally reflected from the second boundary surface towards the first boundary surface at a correspondingly lower angle of incidence.

2. A backlight panel as claimed in claim 1, in which the peripheral edge comprises a pair of opposite lateral edge portions.

3. A backlight panel as claimed in claim 2, in which said elongate surface relief features extend between said lateral edge portions.

4. A backlight panel as claimed in claim 2, in which the areal density of said first pattern varies in the lateral direction and generally increases towards the lateral edge portions.

5. A backlight panel as claimed in claim 1, in which the second pattern is a striped pattern.

6. A backlight panel as claimed in claim 1, in which the proportion of the second boundary surface covered by the elongate surface relief features as compared with said second planar surface defines an areal density of said second pattern and the areal density of said second pattern varies across the second side and generally increases along the transmission direction towards said terminal edge portion.

7. A backlight panel as claimed in claim 1, in which each of said elongate surface relief features extends continuously across the second pattern.

8. A backlight panel as claimed in claim 1, in which said elongate surface relief features comprise grooves in the second planar surface, each groove having one side wall which provides said inclined surface.

9. A backlight panel as claimed in claim 1, in which said elongate surface relief features comprise grooves in the second planar surface, each groove being V-shaped in cross-section, a first side of said cross-section providing said inclined surface.

10. A backlight panel as claimed in claim 9, in which a second side of said V-shaped cross-section is inclined with respect to the second planar surface at an opposite angle to that of the first side of said V-shaped cross-section.

11. A backlight panel as claimed in claim 1, in which said elongate surface relief features comprise ridges in the second planar surface, each ridge having one side wall which provides said inclined surface.

12. A backlight panel as claimed in claim 1, in which said elongate surface relief features comprise ridges in the second planar surface, each ridge having opposite ramp sides, wherein a first side of said ramp sides providing said inclined surface and a second ramp side of said ridge is inclined with respect to the second planar surface at an opposite angle to that of the first ramp side of said ridge.

13. (canceled)

14. A backlight panel as claimed in claim 1, in which the angle of said inclined surfaces generally increases along the transmission direction.

15. A backlight panel as claimed in claim 1, in which said source of illumination injects light into the light pipe along substantially the entire input edge portion, and the second pattern is a pattern of substantially straight elongate surface relief features.

16. A backlight panel as claimed in claim 1, in which said source of illumination injects light into the light pipe at a central part of the input edge portion, and the second pattern is a pattern of substantially concentric arcs centred generally on said central part.

17. A backlight panel as claimed in claim 1, in which the first pattern includes a region of increased areal density adjacent said input edge portion.

18. A backlight panel as claimed in claim 1, in which said discrete surface relief features comprise pits in the first planar surface, wherein said pits are substantially hemi-spherical.

19. (canceled)

20. A backlight panel as claimed in claim 1, in which said discrete surface relief features comprise bumps on the first planar surface, wherein said bumps are substantially hemispherical.

21. (canceled)

22. A backlight panel as claimed in claim 1, in which the peripheral edge comprises a terminal edge portion towards which said injected light is generally transmitted.

23. A panel display, comprising a graphic display device for displaying one or more graphic information features to a user and a backlight panel for providing area backlighting of a panel display device, the graphic display device having a front face and a rear face, the front face being oriented to present said graphic information features to a user of the panel display, and the rear face being configured to receive said backlight illumination from the first side of the backlight panel.
